(19) United States
(12) Patent Application Publication
(10) Pub. No.: US 2024/0026096 A1
(43) Pub. Date: Jan. 25, 2024

(54) TUBE AND METHOD FOR MAKING SAME

(71) Applicant: SAINT-GOBAIN PERFORMANCE PLASTICS CORPORATION, Solon, OH (US)

(72) Inventors: Hua WANG, Northbridge, MA (US); Choung-Houng LAI, Acton, MA (US); Michael J. TZIVANIS, Chicopee, MA (US); Mark w. SIMON, Sutton, MA (US); Nicholas WATKINS, Waltham, MA (US); Shuai LIANG, Southborough, MA (US); Zachary COSTANTINO, Framingham, MA (US)

(21) Appl. No.: 18/356,174

(22) Filed: Jul. 20, 2023

Related U.S. Application Data
(60) Provisional application No. 63/368,929, filed on Jul. 20, 2022.

(51) Int. Cl. C08J 5/00; C08K 7/26

(52) U.S. Cl. CPC C08J 5/005; C08K 7/26; C08J 2323/20

(57) ABSTRACT

A tube includes a layer including a polymer matrix and a refractive index domain dispersed within the polymer matrix, wherein the refractive index domain has a refractive index less than a refractive index of the polymer matrix, the layer having a refractive index of less than 1.42.

### CROSS-REFERENCE TO RELATED APPLICATION(S)

This Application claims priority under 35 U.S.C. § 119(e) to U.S. Provisional Patent Application No. 63/368,929, entitled “TUBE AND METHOD FOR MAKING SAME,” filed Jul. 20, 2022, by Hua WANG et al., which is assigned to the current assignee hereof and is incorporated herein by reference in its entirety.

### FIELD OF THE DISCLOSURE

This application, in general, relates to a tube and a method for making the same, and in particular, relates to a conduit for a liquid fragrance.

### BACKGROUND

In many industries, product marketing can be a challenging and complex process, and despite the underlying virtues of a product, marketing approaches continue to play a significant role in product success and ultimately the success of the vendor. Particularly, in modish industries, such as fashion apparel, fashion accessories, cosmetics, fragrances and other personal beauty products, the marketability of a product is determined in a large part by aesthetically pleasing product packaging and presentation. As such, the ability to develop and present a product in a unique and desirable manner is of the highest priority for vendors of modish products.

In the context of personal beauty products, a consumer may be more likely to purchase a product packaged in an aesthetically pleasing manner. Consequently, manufactures have developed techniques to conceal or obscure non-decorative and functional packaging components. Such techniques include the use of creative designs and colors on the exterior of containers. Other manufacturers have provided such decorations on both interior and exterior packaging parts to conceal components of the packaging or of the product itself. In the particular context of fragrance products, dispensing mechanisms represent a notable aesthetic challenge.

Accordingly, in view of the foregoing, there is a continuous need in the industry for improvements in product packaging. Moreover, manufacturers continue to demand new and unique techniques related to product design and packaging in order to gain a competitive edge.

### SUMMARY

In an embodiment, a tube includes: a layer including a polymer matrix and a refractive index domain dispersed within the polymer matrix, wherein the refractive index domain has a refractive index less than a refractive index of the polymer matrix, the layer having a refractive index of less than 1.42.

In another embodiment, a method of forming a tube includes: providing a polymer matrix; and dispersing a refractive index domain in the polymer matrix wherein the refractive index domain has a refractive index less than a refractive index of the polymer matrix; and forming the polymer matrix into a layer, the layer having a refractive index of less than 1.42.

In another embodiment, a fragrance product includes a container containing liquid fragrance; and a dispenser assembly for dispensing the liquid fragrance including: a transport assembly; and a tube connected to the transport assembly and extending into the liquid fragrance, wherein the tube includes a non-fluoropolymer matrix and a refractive index domain dispersed within the non-fluoropolymer matrix, wherein the refractive index domain has a refractive index less than a refractive index of the non-fluoropolymer matrix, the tube having a refractive index of less than 1.42.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube according to an embodiment.

FIG. 2 includes an illustration of an exemplary multilayer tube according to an embodiment.

FIG. 3 is an illustration of a system including a tube immersed in and containing a liquid fragrance, the liquid fragrance product and tube having an index of refraction difference of 0.10.

FIG. 4 is an illustration of a system including a tube immersed in and containing a fluid, the fragrance product and tube having an index of refraction difference of 0.02.

FIG. 5 is an illustration of a system including a tube immersed in and containing a fluid, the fragrance product and tube having an index of refraction difference of 0.00.

FIG. 6 is an illustration of a system including a tube immersed in and containing a fluid, the fragrance product and tube having an index of refraction difference of 0.02.

FIG. 7 is an illustration of a fragrance product including a container and dispenser assembly according to one embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

According to one embodiment, a tube includes a layer including a polymer matrix and a refractive index domain dispersed within the polymer matrix. The refractive index domain has a refractive index that is less than a refractive index of the polymer matrix. In an embodiment, the layer has a refractive index of less than 1.42, such as about 1.34 to about 1.40, such as about 1.36 to about 1.40, or even 1.36 to 1.38. In a particular embodiment, a fragrance product includes a container containing a liquid fragrance and a dispenser assembly for dispensing the liquid fragrance, wherein the dispenser assembly includes a transport assembly and the tube. The tube extends into the liquid fragrance and is connected to the transport assembly. According to this embodiment, the tube, and the liquid fragrance each have a refractive index and the difference (absolute value) between the refractive index of the tube and the liquid fragrance is not greater than about 0.04.

Referring to the tube, the tube provides a conduit for transporting the liquid fragrance product from the container, through the transport assembly, to the consumer. The tube extends into the liquid fragrance and by capillary action the liquid fragrance fills the tube to a particular level. According to one embodiment, the tube can be comprised of a polymer matrix that is a non-fluoropolymer. A “non-fluoropolymer” as used herein refers to a polymer material that does not include fluorine elements within the polymer matrix. Any non-fluoropolymer with a desirable initial refractive index (without any refractive index domain dispersed therein) is envisioned. An exemplary non-fluoropolymer may be formed of a homopolymer, copolymer, terpolymer, or polymer blend formed from a silicone polymer, a polyolefin, a polycarbonate, a cellulose triacetate, a cellulose ester, a polymethyl methacrylate, an epoxy, a cyclic olefin copolymer, a polyvinyl chloride, an amorphous copolyester, a polyethylene terephthalate, an ionomer resin, an acrylonitrile butadiene styrene (ABS), a styrene methyl methacrylate, a polystyrene, or combination thereof. In a particular embodiment, the non-fluoropolymer matrix includes a silicone polymer, a polyolefin, a polycarbonate, a cellulose triacetate, a cellulose ester, or combination thereof. In a more particular embodiment, the silicone polymer is a liquid silicone rubber (LSR), a high consistency gum rubber (HCR), and the like.

In an embodiment, the non-fluoropolymer includes a polyolefin. Any reasonable polyolefin is envisioned. For instance, the polyolefin includes a polymethyl pentene (PMP), a polypropylene (PP), a cyclic olefin copolymer, or combination thereof.

In a particular embodiment, the polymer matrix, such as the non-fluoropolymer, has an advantageous refractive index. For instance, the polymer matrix has a refractive index of less than 1.60, such as 1.40 to 1.60, such as 1.45 to 1.50. Further, the polymer matrix is optically clear. In a particular embodiment, the polymer matrix has an advantageous light transmission.

For instance, as a tube in a fragrance product, the polymer matrix should have a light transmission that facilitates a desirable, low visibility optical effect of the tube when immersed in and containing a liquid fragrance. For instance, the polymer matrix has a light transmission of greater than about 80%, such as greater than about 85%, such as greater than about 90%, or even greater than about 95%.

The tube further includes a refractive index domain dispersed within the polymer matrix. A “refractive index domain” as used herein refers to discrete particles or spaces within the polymer matrix. “Discrete” as used herein refers to a particle or space that is not aggregated or interconnected to another particle or space. In particular, the refractive index domain has a refractive index that is lower than the refractive index of the polymer matrix. In an embodiment, the refractive index domain has an advantageous average diameter size. For instance, the refractive index domain has an average diameter size of about 400 nanometer (nm) or less, such as 1 nm to 400 nm, such as 5 nm to 200 nm, such as 20 nm to 200 nm, or even 10 nm to 100 nm. In a particular embodiment, the average diameter size is less than the wavelength of visible light.

Any refractive index domain is envisioned that decreases the refractive index of the polymer matrix. For instance, the refractive index domain includes an air bubble, a hollow nanoparticle such as a hollow silica nanoparticle, a hollow polymer nanoparticle, a hollow glass nanoparticle, a hollow ceramic nanoparticle, an aerogel, or combination thereof. For instance, the refractive index domain is an air bubble. The air bubble may be formed by any reasonable method and includes, for example, nano-foaming, using a degradable nanoparticle, or combination thereof.

In an exemplary embodiment, the refractive index domain is a hollow silica nanoparticle. In an embodiment, the refractive index domain is a hollow silica nanoparticle that has desirable properties. In a particular embodiment, the desirable hollow silica particles have one or more of the following characteristics: mesopore-free (for example, a dense solid shell that is free of pores), small diameter (from 20 nm to 200 nm), and/or a shell thickness (from 2 nm to 30 nm).

In another exemplary embodiment, the hollow silica nanoparticle is an optically transparent aerogel. The aerogel domain is highly transparent due to its small pore sizes (approximately 20 nm average diameter). In an embodiment, optically transparent silica aerogel with small primary silica particles (<1 nm diameter) aggregate together to form larger secondary silica particles (about 1-3 nm in diameter). These secondary particles bond together to form aerogel with an interconnected necklace structure that provides a highly mesoporous network. The mean pore size may be between 10-30 nm. The aerogel has a porosity of over 95% and an optical transmittance of 98-99%. The mesoporous network comprising the aerogel may be supplied over a large range of particle sizes depending on the grinding or milling conditions. For instance, the aerogel has a mean particle size of less than about 50 μm, such as less than 40 μm, such as less than 30 μm. In an embodiment, the aerogel has a mean particle size of 1 μm to 50 μm, such as 1 μm to 40 μm, or even 1 μm to 30 μm. In an embodiment, the aerogel can be milled to a size of even less than 1 μm.

In another embodiment, the refractive index domain is a hollow polymer nanoparticle. The polymer shells of the hollow polymeric nanoparticle may be a homopolymer, copolymer, or polymeric blend of a synthetic or nature-derived material. For instance, the hollow polymer nanoparticle includes a polymer shell including a bio-based macromolecule, an amphiphilic polymer, a synthetic polymer, or combination thereof. The polymer shell may or may not be cross-linked. Although not being bound by theory, crosslinking may increase the intramolecular bonds within the material. In an embodiment, the hollow polymer nanoparticle includes a polymer shell including the bio-based macromolecule. Any bio-based macromolecule is envisioned that is biologically-based. For instance, the bio-based macromolecule may be a protein, a lipid, a polypeptide, chitosan, or combination thereof. In another embodiment, the polymer shell includes an amphiphilic polymer. Any amphiphilic polymer is envisioned and includes, for example, a polystyrene-poly(acrylic acid) block copolymer (PS-b-PAAC), a polyethylene oxide-poly(butyl acrylate) block copolymer (EO-b-PBA), or combination thereof. In yet another embodiment, the polymer shell includes a synthetic polymer. Any synthetic polymer is envisioned. In an example, the synthetic polymer includes polysiloxane, polymethyl methacrylate (PMMA), polyvinyl alcohol (PVA), polyvinylidene difluoride (PVDF), polyvinyl chloride (PVC), acrylonitrile butadiene styrene (ABS), polylactic acid (PLA), polydopamine (PDM), polystyrene-poly(methyl methacrylate) copolymer (PS-PMMA), a cyclic olefin copolymer, or combination thereof.

In a particular embodiment, the refractive index domain is homogenously dispersed within the polymer matrix. “Homogenous dispersion” refers to a uniform distribution of the refractive index domains throughout the polymer matrix. In an embodiment, the refractive index domain is present in an amount to provide the desirable refractive index for the final tube. Any amount of refractive index domain is envisioned and includes, for example, a volume fraction of about 2% to about 70% based on the total volume of the layer. It will be appreciated that the volume fraction can be within a range between any of the minimum and maximum values noted above.

In a further embodiment, the material of the tube may include any additive envisioned. The additive may include, for example, a curing agent, an antioxidant, a filler, an ultraviolet (UV) agent, a dye, a pigment, an anti-aging agent, a plasticizer, the like, or combination thereof. In an embodiment, the curing agent is a cross-linking agent provided to increase and/or enhance crosslinking of the non-fluoropolymer matrix material. In a further embodiment, the use of a curing agent may provide desirable properties such as decreased permeation of small molecules and improved elastic recovery of the material compared to a material that does not include a curing agent. Any curing agent is envisioned such as, for example, a dihydroxy compound, a diamine compound, an organic peroxide, or combination thereof. An exemplary dihydroxy compound includes a bisphenol AF. An exemplary diamine compound includes hexamethylene diamine carbamate. In an embodiment, the curing agent is an organic peroxide. Any amount of curing agent is envisioned. Alternatively, the non-fluoropolymer matrix material may be substantially free of a crosslinking agent, a curing agent, a photoinitiator, a filler, a plasticizer, or a combination thereof. “Substantially free” as used herein refers to less than about 1.0% by weight, or even less than about 0.1% by weight of the total weight of the non-fluoropolymer material.

In an embodiment, the polymer matrix is crosslinked. Although not being bound by theory, crosslinking may increase the intramolecular bonds within the polymer matrix. In a particular embodiment, crosslinking of the polymer matrix improves the tensile modulus of the final tube. For instance, the crosslinked tube has a tensile modulus of at least 30 ksi, such as at least 35 ksi, or even at least 38 ksi as measured by ASTM D638. In an embodiment, the crosslink density may be tuned to minimize the polymeric material's ability to swell in alcohol and/or increase its mechanical properties. Any reasonable method of crosslinking is envisioned. For instance, the polymer matrix may be cross-linked via radiation such as via ultraviolet radiation, electron-bean radiation, gamma radiation, or combination thereof. In an embodiment, the radiation includes electron beam radiation. In a more particular embodiment, the electron beam radiation is at 30 kGy to 750 kGy. In another embodiment, the electron beam radiation is at 100 kGy to 300 kGy.

Methods of crosslinking may be dependent on the polymer matrix chosen. In an example, the polymer matrix is a silicone material. When the polymer matrix is a silicone material, the crosslink reaction could be either thermal cured, catalyzed by platinum (Pt), or using acrylic functionalized silicone polymer, cured by UV light. In an example, platinum method formulation will be prepared based on a modified commercial package and UV cured. The method of crosslinking may be prior to or after forming the tube. For instance, the silicone material can be partially crosslinked prior to extrusion and then extruded into a final product, such as a tube. In another embodiment, the silicone material can be extruded and then crosslinked.

In a particular embodiment, the layer includes the polymer matrix and the refractive index domain. In an example, the layer may consist essentially of the polymer matrix and the refractive index domain. As used herein, the phrase “consists essentially of” used in connection with the polymer matrix and the refractive index domain of the layer precludes the presence of other monomers that affect the basic and novel characteristics of the layer, although, commonly used processing agents and additives such as antioxidants, fillers, UV agents, dyes, pigments, anti-aging agents, and any combination thereof may be used in the layer. In a particular example, the layer may consist of a polymer matrix and a refractive index domain.

According to one embodiment, the tube is hollow, thin-walled and has a fine geometry, having an ID (inner diameter) within a range of about 0.1 mm to about 3.0 mm, such as 0.1 mm to about 2.0 mm, or 0.1 mm to about 1.0 mm. A particular sample has an ID of 0.95 mm. OD (outside diameter) is generally within a range of about 0.25 mm to 10.0 mm, such as 0.5 mm to 5.0 mm, or 0.5 mm to 3.0 mm. A particular OD is 1.65 mm. Generally, the tube has a uniform wall thickness, within a range of about 0.05 mm to about 3.0 mm, such as 0.1 mm to 1.0 mm, and most often within a range of about 0.1 mm to 0.75 mm. A particular wall thickness is 0.35 mm to 0.38 mm. It will be appreciated that the ID, OD, and wall thickness can be within a range between any of the minimum and maximum values noted above.

FIG. 1 is a view of a tube 100 according to an embodiment. In a particular embodiment, the tube 100 can include a body 102 having an outside diameter 104 and an inner diameter 106. The inner diameter 106 can form a central lumen 108 of the body 102. The hollow bore 108 defines a central lumen of the tube. In addition, the body 102 is illustrated as a layer, the layer including the polymer matrix and refractive index domain described above. The layer can include a layer thickness 110 that is measured by the difference between the outside diameter 104 and the inner diameter 106.

Further, the body 102 can have a length 112, which is a distance between a distal end 114 and a proximal end 116 of the 100. In a further embodiment, the length 112 of the body 102 can be at least about 2 centimeters (cm), such as at least about 5 cm, such as at least about 8 cm. The length 112 is generally limited by pragmatic concerns, such as storing and transporting lengths, or by customer demand.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

In a particular embodiment, the layer including the polymer matrix and refractive index domain is provided by any method envisioned. For instance, the polymer matrix and refractive index domain may be provided by any method envisioned and is dependent upon the polymer material and refractive index domain chosen for the layer.

In a particular embodiment, the layer may be provided by any method envisioned and is dependent upon the polymer matrix material chosen. In an embodiment, the polymer matrix material is melt processable. “Melt processable” as used herein refers to a polymer material that can melt and flow to extrude in any reasonable form such as films, tubes, fibers, molded articles, or sheets. For instance, the melt processable polymer material is a flexible material. In an embodiment, the layer is extruded, injection molded, or mandrel wrapped. In an exemplary embodiment, the layer is extruded. The layer may be cured in place using a variety of curing techniques such as via heat, radiation, or any combination thereof.

Further, the method of providing the refractive index domain is dependent on the refractive index domain. For instance, when the refractive index domain is a hollow silica nanoparticle and/or a hollow polymer nanoparticle, the nanoparticle is dispersed within the polymer matrix. In an embodiment the hollow silica nanoparticle is a silica aerogel. Dispersion includes mixing the nanoparticle into the polymer matrix. Dispersion of the nanoparticle into the polymer matrix occurs prior to forming the layer into a tube. For example, the nanoparticles are compounded in a polymer matrix through an extruder. Alternatively, the nanoparticles are mixed with a polymer in a liquid state directly (for example, a silicone LSR) or in a polymer-solvent solution. In addition, the nanoparticles can also be dry blended with polymer powders. Any treatment of the hollow silica nanoparticle and/or the hollow polymer nanopolymer is envisioned that can aid in the dispersion or prevent undesirable agglomeration. Examples include, but are not limited to a dispersant, a surface active agent, an anionic surfactant, a cationic surfactant, a non-ionic surfactant, an amphoteric surfactant, a zwitterionic surfactant, a silane, or combination thereof.

When the refractive index domain is an air bubble, the air bubble may be formed with a degradable nanoparticle or via a nano-foaming process. A degradable nanoparticle includes any nanomaterial that degrades under certain conditions, such as heat, pressure, and the like. In an embodiment, any degradable nanoparticle is envisioned and includes, for example, a silicone-polyethylene glycol (PEG) block copolymer, an ammonium bicarbonate encapsulated in a polymeric shell, an ammonium carbonate solution encapsulated in a polymeric shell, or combination thereof. For instance, a silicone-polyethylene glycol (PEG) block copolymer may be dispersed into a polymer matrix, such as a silicone matrix. After the layer is formed, it is heated and the PEG domains decompose at temperature slightly below 200° C. The PEG decomposition creates nano-voids that are well dispersed in the silicone matrix to reduce the refractive index of the tube.

The refractive index domain within the layer may also be formed via nano-foaming. Any nano-foaming method is envisioned. In an embodiment, nano-foaming includes the use of physical blowing agents or by expansion techniques applying a supercritical fluid. During a foaming process using physical blowing agents, the polymer may be saturated with a blowing agent at high pressure, typically in the range of 0.1 to 35 MPa. The polymer/gas mixture may then be quenched into a super-saturated state by reducing pressure, increasing temperature, or combination thereof. Afterwards, nucleation and growth of gas cells dispersed throughout the polymer sample evolve to form a foaming structure. The foaming process can either be continuous (for example, through continuous extrusion process), or batch process (for example, using an autoclave).

When using an expansion technique, applying supercritical fluids, swelling agents or anti-solvent are typically used. Materials with nano-sized porous structures can be formed. Any method is envisioned. For example, solid-state foaming processes may be based on low-temperature carbon dioxide (CO₂) saturation. Any saturation temperature and foaming temperature is envisioned to achieve the desirable pore size and resulting refractive index. Pore size may be tuned for an advantageous refractive index. In an embodiment, the foamed tube may be further treated to render them unwettable by perfume ingredients. For instance, the foamed tube may be treated with an omniphobic or superomniphobic coating.

In one example, the layer may be formed. The layer may then be treated using supercritical carbon dioxide (CO₂) at various saturation temperatures and foaming temperatures to render the tubing to have an effective refractive index of less than 1.42, such as about 1.34 to about 1.40, such as about 1.36 to about 1.40, or even 1.36 to 1.38. The foamed layer may then be further treated (such as application of omniphobic or superomniphobic coatings) to render it unwettable by alcohols and other perfume ingredients.

In an embodiment, the tube consists essentially of a single layer. As used herein, the phrase “consists essentially of” used in connection with the single layer of the tube precludes the presence of other layers that affect the basic and novel characteristics of the refractive index of the final tube. In an embodiment, the tube consists of a single layer.

In an alternative embodiment, the tube includes multiple layers. In an example, the layer including the polymer matrix and the refractive index domain dispersed therein may be a coating. The coating layer may be applied on the inner surface, the outer surface, or combination thereof of the tubing. In a particular embodiment, the coating layer should have a refractive index that is lower than that of a base tubing polymer. In an example, the material selected for the base layer may be chosen to provide advantageous properties. Any property is envisioned and depends on the final properties desired for the final tube. For instance, the material for the base layer may be selected for an advantageous mechanical strength of the final tube. In an embodiment, the base layer may have an advantageous tensile strength to provide the final tube with a desirable tensile modulus in combination with desirable refractive index. In an embodiment, the base tubing polymer may be any non-fluoropolymer polymer described above. In an embodiment, the base tubing polymer has a desirable light transmission, such as greater than about 80%, such as greater than about 85%, such as greater than about 90%, or even greater than about 95%. In a particular embodiment, the refractive index domain is dispersed in a pre-polymer or a polymer solution.

In another embodiment, a multilayer polyelectrolyte may be used to make a nano-porous coating. Any method of making the multilayer polyelectrolyte is envisioned. In an embodiment, the nano-porous refractive index domain can be generated by the sequential adsorption of a poly(acrylic acid) and poly(allylamine hydrochloride) from an aqueous solution followed subsequently by a pH treatment step, such as an acid solution treatment. Optionally, the method may include a neutral water soaking step. In an example, the properties of the pores may be controlled by modifying the method. For instance, the method may be modified by changing the pH level, the residence time of the pH treatment step, crosslinking to control pore stability, using surface treatment, or combination thereof.

In one embodiment of making a nano-porous coating, a base layer, such as a polymethyl pentene (PMP) layer or a silicone layer, is first extruded into a tube. The base layer is then coated on an inner surface, an outer surface, or combination thereof with the PAA/PAH polyelectrolyte multilayer film, followed by pH treatment and neutral water soaking to make a tubing with a range of coating thickness (such as, for example, from 100 nm to 1 μm) and porosity (such as, for example, 2-30%) while keeping the pores discrete with small pore size (such as, for example, less than 100 nm).

In an embodiment, the tube includes multiple layers of a polymeric material. For instance, the multilayer tube includes an inner layer including a first material, a base (mid) layer including a second material, and an outer layer of a third material. In a particular embodiment, the first material and the third material have the same refractive index. The same refractive index may be achieved by any means, such as using the same material for the first material and the third material with the same thickness. In an embodiment, different materials may be used for the first material and the third material having the same or different thicknesses with the proviso that the first material and the third material have the same refractive index. In an embodiment, the first material, the third material, or combination includes a layer as described above including the polymer matrix and the refractive domain index.

Although not being bound by theory, with an inner layer and an outer layer having the same refractive indices, any material is envisioned for the base layer. Typically, the second material of the base layer has a refractive index that is different than the refractive index of the first material and the third material. In an embodiment, the first material and the third material have a refractive index that is less than the refractive index of the second material. In an embodiment, the first material and the third material have a refractive index that is lower than the refractive index of the second material. In an example, the material selected for the base layer may be chosen to provide advantageous properties. Any property is envisioned and depends on the final properties desired for the final tube. For instance, the material for the base layer may be selected for an advantageous mechanical strength of the final tube. In an embodiment, the base layer may have an advantageous tensile strength to provide the final tube with a desirable tensile modulus in combination with desirable refractive index. In an embodiment, the second material of the base layer includes the non-fluoropolymer polymer material described above. In a particular embodiment, the second material of the base layer is a polymethyl pentene (PMP), polypropylene, poly methyl methacrylate (PMMA), a silicone, combination thereof, and the like.

In an exemplary embodiment, the base layer provides an advantageous tensile strength to the final tube while the inner layer and the outer layer provide an advantageous refractive index. In an embodiment, the base layer directly contacts the inner layer and the outer layer.

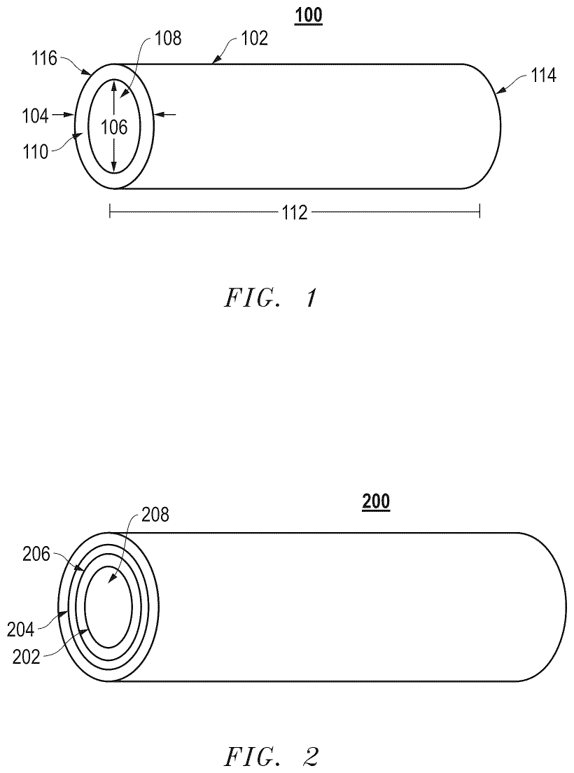

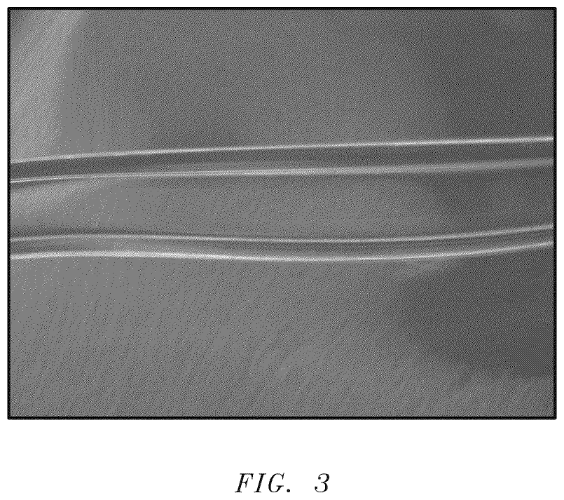

In an example, FIG. 2 includes an illustration of a multilayer tube 200. In an embodiment, the tube 200 includes an inner layer 202, an outer layer 204 and a base layer 206. For example, the inner layer 202 may directly contact the base layer 206. In a particular example, the inner layer 202 forms a central lumen 208 of the tube 200 and is described as the first layer above. The base layer 206 may be directly bonded to the inner layer 202 without intervening layers. The outer layer 204 may directly contact and surround the base layer 206. The outer layer 204 is the third layer as described above.

Returning to FIG. 2, the inner layer 202 has the same refractive index as the outer layer 204. For example, the total thickness of the layers of the multilayer tube 200 may be the same as the thickness described for the single layer tube 100 of FIG. 1. In an embodiment, the inner layer 202 has a thickness in a range of about 0.01 mm to about 0.40 mm, such as a range of about 0.03 mm to about 0.12 mm. The base layer 206 and outer layer 204 may make up the difference. In an embodiment, the outer layer 204 has a thickness that is the same as the thickness of the inner layer 202. In an embodiment, the outer layer 204 has a thickness that is different as the thickness of the inner layer 202, with the proviso that the outer layer 204 and the inner layer 202 have the same refractive index. In an example, the outer layer 204 may have a thickness in a range of about 0.01 mm to about 0.40 mm, such as a range of about 0.03 mm to about 0.12 mm. In a more particular embodiment, the inner layer 202 has a thickness that is greater than the base layer 206. In an example, the inner layer 202 and the outer layer 204 each have a thickness that is greater than the thickness of the base layer 206. In an embodiment, the thickness of the base layer 206 is greater than a thickness of the inner layer 202, outer layer 204, or combination thereof. For instance, the base layer 206 may have a thickness of about 0.01 mm to about 0.40 mm, such as a range of about 0.02 mm to about 0.12 mm. It will be appreciated that the thickness values can be within a range between any of the minimum and maximum values noted above.

While three layers are illustrated in FIG. 2, the multilayer tube 200 may further include additional layers (not illustrated). Any additional layer may be envisioned such as an additional tie layer, an elastomeric layer, or combination thereof. Any position of the additional layer on the multilayer flexible tube 200 is envisioned. For instance, an additional elastomeric layer may be disposed on surface 210 of the outer layer 204. In an embodiment, the multilayer tube consists essentially of the inner layer, the base layer, and the outer layer. As used herein, the phrase “consists essentially of” used in connection with the multilayer tube precludes the presence of other layers that affect the basic and novel characteristics of the refractive index of the final tube. In an embodiment, the tube consists of the inner layer, the base layer, and the outer layer.

In a particular embodiment, any method of forming the layers is envisioned to provide for a multilayer tube and is dependent on the material chosen for each layer. Any order of forming the layers is envisioned. Any method of providing a refractive index domain in any of the layers is envisioned. For instance, a base polymer layer may be provided that does not include any refractive index domain. In an example, the base polymer layer is extruded, injection molded, or mandrel wrapped. In an exemplary embodiment, the base polymer layer is extruded. Further, the layer may be cured in place using a variety of curing techniques such as via heat, radiation, or any combination thereof.

In another embodiment, an outer layer is provided over the base polymer layer, the outer layer including the polymer matrix and refractive index domain. The outer layer may be provided as a coating as described above or any other method described for forming the layer with the polymer matrix and the refractive index domain. For instance, the outer layer may be extruded. In an embodiment, the outer layer is provided by heating the polymer to an extrusion viscosity and then extruding the polymer. For instance, when the outer layer is a polymer material that is different than the polymer material of the base layer, the outer layer is coated, extruded, injection molded, or mandrel wrapped. The refractive index domain in the outer layer may be provided by any method described. In a particular embodiment, the outer layer directly contacts the base layer. Further, any of the layers may be cured in place using a variety of curing techniques such as via heat, radiation, or any combination thereof.

In an embodiment, the multilayer tube includes at least three layers such as an inner layer, a base layer (i.e., mid layer), and an outer layer. The method may further include providing the inner layer by any method. Providing the inner layer depends on the polymeric material chosen for the inner layer. In an embodiment, the inner layer includes the polymer matrix and refractive index domain. In an embodiment, the inner layer is a material that has the same refractive index as the outer layer. In a more particular embodiment, the inner layer is the same material having the same thickness as the outer layer. In an alternative embodiment, the inner layer is a different material with the same or different thickness as the outer layer, with the proviso that the outer layer has the same refractive index as the inner layer. In an embodiment, the inner layer is coated, extruded, or injection molded. The refractive index domain in the inner layer may be provided by any method described. In an exemplary embodiment, the inner layer is provided prior to providing the base layer. In another embodiment, the inner layer is provided after providing the base layer. In yet another embodiment, the inner layer and the base layer are provided concurrently. In an example, the inner layer is disposed to directly contact the base layer. Further, the layer may be cured in place using a variety of curing techniques such as via heat, radiation, or any combination thereof.

In an embodiment, any combination of the inner layer, the base layer, and the outer layer may be co-extruded. In another embodiment, the base layer is provided, and the inner layer and the outer layer are coated concurrently or sequentially. When the tube includes multiple layers, any order of providing the layers together or individually is envisioned. Furthermore, the refractive index domain in the inner layer, the outer layer, or combination thereof may be provided by any method described.

Advantageously, the inner layer, the base layer, and the outer layer may also be bonded together (e.g., coextruded) at the same time, which may enhance the adhesive strength between the layers. In particular, the inner layer, the base layer, and the outer layer have cohesive strength between the three layers, i.e., cohesive failure occurs wherein the structural integrity of the inner layer, the base layer, and the outer layer fails before the bond between the three layers fails. In a particular embodiment, the adhesive strength between the inner layer and the base layer is cohesive. In an embodiment, the adhesive strength between the base layer and the outer layer is cohesive.

In an embodiment, at least one layer may be treated to improve adhesion between the inner layer, the base layer, and the outer layer. Any treatment is envisioned that increases the adhesion between two adjacent layers. For instance, a surface of the inner layer that is directly adjacent to the base layer is treated. In an embodiment, the surface of the base layer that is directly adjacent to the outer layer is treated. Further, a surface of the outer layer that is directly adjacent to the base layer is treated. In an embodiment, the treatment may include surface treatment, chemical treatment, sodium etching, use of a primer, or any combination thereof. In an embodiment, the treatment may include corona treatment, UV treatment, electron beam treatment, gamma treatment, flame treatment, scuffing, sodium naphthalene surface treatment, or any combination thereof.

In an embodiment, any post-cure steps may be envisioned. In particular, the post-cure step includes any thermal treatment, radiation treatment, or combination thereof. Any thermal conditions are envisioned. In an embodiment, the post-cure step includes any radiation treatment such as, for example, electron beam treatment, gamma treatment, or combination thereof. In an example, the gamma radiation or ebeam radiation is at about 62 kGy to 750 kGy. In a particular embodiment, the post-cure step may be provided to eliminate any residual volatiles, increase crosslinking, or combination thereof.

According to one embodiment, a fragrance product includes a container containing a liquid fragrance and a dispenser assembly for dispensing the liquid fragrance, wherein the dispenser assembly includes a transport assembly and the tube. In an embodiment, the container is substantially transparent. A variety of degrees of transparency are suitable, as it will be appreciated that the transparency of the container is a function of packaging and customer appeal. While opaque fragrance product containers have been utilized in the industry, typically the present container is at least translucent or, more typically, substantially transparent. Use of substantially transparent containers herein may facilitate the viewing of the liquid fragrance and provide a sense of clarity and assurance to the consumer in the purchased product. Most often, the substantially transparent container has a tint or color, generally a tint or color that is not native to the material of the container, which is generally a glass such as a silica-based glass.

Referring to the liquid fragrance within the container, as used herein, the term “fragrance” is used to define a substance that is applied to a person, and which diffuses an aroma for its aesthetic and/or functional qualities. According to an embodiment, the liquid fragrance includes at least one of a base note, middle note, and a top note. The term “note” can refer to a single scent of a perfume or it can refer to the degree of volatility of certain fragrant compounds. Accordingly, compositions categorized as top notes have the highest degree of volatility and therefore the fragrance is brief. Depending upon the manufacturer, a fragrant compound of the top note variety typically lasts only a few minutes and is described as an assertive or sharp scent. Compositions categorized as middle notes (also referred to as heart notes) have a moderate volatility and emerge after the top note evaporates. A middle note, appears anywhere from about 10 minutes to an hour after the initial application. A base note composition has the most long lasting fragrance and is a rich or deep scent, generally appearing about 30 minutes to an hour after the initial application. According to one embodiment, the fragrance contains compositions of more than one note, which is referred to as an accord or a combination of scents that derive a different and distinct scent. In another embodiment, the fragrance contains a mixture of all three notes.

According to another embodiment, the liquid fragrance is categorized as a perfume extract, perfume, eau de toilette, eau de cologne, or aftershave. The distinction between these categorizations of personal fragrance compositions indicates the percentage of aromatic compounds present in the fragrance. As used herein, a perfume extract contains about 20-40% aromatic compounds while an eau de parfum contains about 10-20% aromatic compounds. An eau de toilette contains about 5-10% aromatic compounds and an eau de cologne contains about 2-3% aromatic compounds, while an aftershave contains about 1-3% aromatic compounds. It is noted that while these values may differ among manufacturers, the hierarchy of the categorization is consistent among manufacturers. Regardless of the differences in percentages between manufacturers, the present liquid fragrance is suitable as any fragrance composition independent of the distinct percentage of aromatic compounds present. Embodiments of the present disclosure are particularly directed to perfume extracts, eau de parfum, and eau de toilettes, and even more particularly perfume extracts and eau de parfum.

In further reference to the liquid fragrance, according to another embodiment, the liquid fragrance generally includes a carrier compound. As indicated by the name, a carrier compound serves to dilute and carry the aromatic compound and a suitable carrier compound includes either an oil or alcohol. As such, suitable carrier oils include naturally-occurring compounds such as those oils from nuts and seeds. For example, common carrier oils are extracted from soybean, sweet almond, aloe, apricot, grape seed, calendula, olive oil, jojoba, peach kernel, and combinations thereof. The carrier compounds may also use an alcohol-based compound, including for example, ethanol, isopropyl, phenol, glycerol or a group of alcohols more commonly referred to as fatty alcohols and combinations thereof.

According to another embodiment, the liquid fragrance also includes an aromatic compound. In one embodiment the aromatic compound is a naturally occurring organic compound, such as an essential oil or a combination of essential oils. Generally, essential oils are a broad class of volatile oils, extracted from plants, fruits, or flowers having a characteristic odor. Generally, the essential oils derive their characteristic odor from one of two basic organic building blocks present within the composition, those being an isoprene unit or a benzene ring. Yet, the aromatic compounds may come from another class of naturally occurring organic compounds, such as an animal-based extract. Alternatively, the aromatic compounds may be synthetically formed to imitate the smell or even reproduce the chemical constituents, and therefore the characteristic odor of the naturally occurring organic compounds. According to another embodiment, the aromatic compound may be synthetically formed to produce a unique smell that is not reproduced by a naturally occurring organic compound.

Independent of the nature of the compound, be it natural or synthetic, the aromatic compounds derive distinct scents from an aromatic functional group. Typically, the aromatic functional groups are formed by a chemical combination of the isoprene unit or benzene ring building blocks discussed above. As such, suitable aromatic functional groups include alcohols, ethers, aldehydes, ketones, esters, lactones, castor oil products, nitrites, terpenes, paraffins, and heterocycles, or combinations thereof. Generally, one aromatic functional group produces one aroma, however a liquid fragrance can contain a mixture of aromatic compounds and aromas, as discussed previously in conjunction with the base, middle and top notes. Accordingly, a liquid fragrance product can contain one or more aromatic compounds with one or more aromatic functional groups.

The liquid fragrance product may further include a fixative, such as a material for binding various aromatic compounds and making the fragrance last for longer durations. A suitable fixative can include naturally occurring materials such as balsams, angelica, calamus, orris, or alternatively an animal-based extract such as ambergris, civet, castoreum or musk. Alternatively, fixatives can be synthesized materials containing derivatives of or equivalents to naturally occurring materials or other materials such as phthalates or glycerin.

Generally, the liquid fragrance has an index of refraction less than about 1.50 such as within a range of between about 1.32 and 1.45. In one embodiment, the liquid fragrance has an index of refraction within a range of between about 1.35 and 1.42, such as in a range of between about 1.36 and 1.40. Still other embodiments have a liquid fragrance with an index of refraction within a range of between about 1.37 and 1.39.

Referring to the dispenser assembly, the dispenser assembly generally includes a mechanism for dispensing the liquid fragrance, for instance, a transport assembly. According to one embodiment, the transport assembly includes a pump for transferring the liquid fragrance product from the interior of the container to the exterior, for application to a person. Generally, the pump uses a pressure differential activated by a variety of mechanisms, such as a button, trigger or bulb actuated by the consumer. According to another embodiment, the transport assembly includes a pneumatic assembly. In a particular embodiment, the liquid fragrance is a perfume, and the transport mechanism is a pneumatic assembly to enable perfume delivery in a mist to the consumer in order to effectively disperse the scent, such as over a broad area of the body, thereby providing a larger area of evaporation for the perfume. Accordingly, in one embodiment, the transport assembly includes a sprayer or atomizer, for delivery of the liquid fragrance in a mist.

According to a particular feature, the difference in refractive indices between the tube and the liquid fragrance is not greater than about 0.040, such as not greater than about 0.035 when the tube is immersed in and contains the liquid fragrance. As used herein, the term “delta” or “difference” in refractive indices is the absolute value of the refractive index of the liquid fragrance subtracted from the refractive index of the material of the tube. In certain embodiments, the delta of such systems having a tube immersed in and containing the liquid fragrance is not greater than about 0.030, such as not greater than about 0.027 or not greater than about 0.025. In some embodiments, the refractive index delta may be less, such as not greater than about 0.020, or not greater than about 0.010. Indeed, the refractive indices may be the same (zero delta).

The refractive features according to embodiments herein are of particular significance. The state of the art has developed container assemblies for storage, transport, and dispensing of fluids having structured components that have an index of refraction approximately that of the fluid. For example, U.S. Pat. No. 6,276,566 describes a technique to mount a three-dimensional design within a container to obscure the functional components of the dispensing container. The disclosed delivery tube and liquid product (typically liquid soaps, shampoos, lotions, oils, and beverages), have indices of refraction within about 0.50 of each other, preferably within about 0.25 of each other. While in perhaps some applications, an index of refraction spread of that order of magnitude can achieve low visibility (concealment) delivery tubes, it has been discovered that particularly in the context of liquid fragrance products, desired concealment or low visibility of structured components requires more closely matched indices of refraction. Further details are provided below in connection with the drawings.

In addition, attention is drawn to the use of refractive index domains as described above. It has been discovered that certain refractive index domains dispersed within a polymeric matrix are particularly useful in carrying out embodiments of the present invention. In this respect, certain polymeric materials have generally not been utilized in fragrance products, due in large part to the matrix material without any refractive index domain generally having an index of refraction within a range of about 1.46 or higher which is particularly undesirable in obtaining target tube visibility levels. Without a refractive index domain, such polymers generally cannot meet the concealment requirements in the context of fragrance products. In contrast, embodiments herein utilize refractive index domains to decrease the refractive index of the polymer material it is dispersed therein. Further, the final tube has a desirable light transmission, such as greater than about 80%, such as greater than about 85%, such as greater than about 90%, or even greater than about 95%.

The low visibility optical effect of the tube immersed in and containing a fluid is illustrated in the accompanying Figures. FIG. 3 is an illustration of a tube immersed in and containing a liquid fragrance, wherein the difference between the refractive index of the tube and the liquid fragrance is about 0.10. Here the liquid fragrance is a perfume having an index of refraction of 1.37, while the tube has an index of refraction of 1.47. The tube is formed of polymethylpentene without any refractive index domain within the polymer matrix. As illustrated in FIG. 3 the features of the tube, namely the edges of inner wall and the outer wall, are distinctly visible within the fluid.

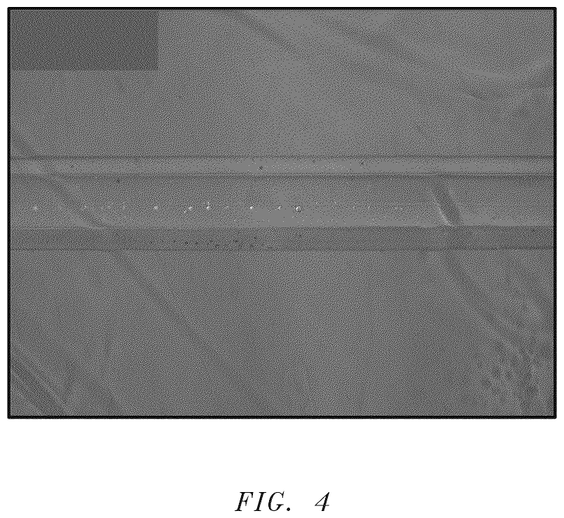

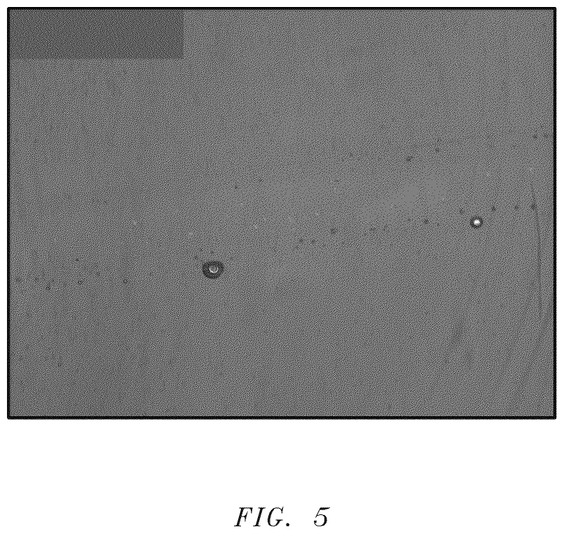

Referring to FIG. 4, a system having a tube immersed in and containing a fluid is illustrated. The delta of the system is approximately 0.02. The low visibility optical effect of the tube within the system is illustrated by a comparison between the systems of FIG. 3 and FIG. 4. As demonstrated in FIG. 3, the features of the tube, such as the inner wall and outer wall, are distinctly visible; however, these same features as illustrated in FIG. 4 are not distinct and less visible. The reduction of the delta from 0.10 in FIG. 3 to 0.02 in FIG. 4, substantially reduces the visibility of the features of the tube to provide a low visibility optical effect.

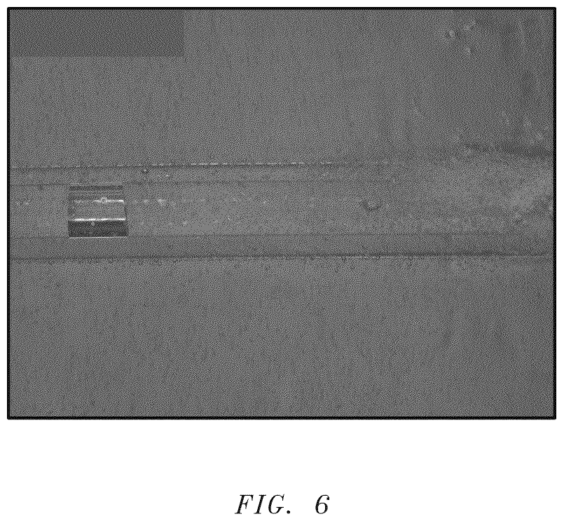

FIG. 5 illustrates a system in which a tube is both immersed in and contains a fluid in which the delta is approximately 0.00 (zero). The low visibility optical effect of the system having a low delta is demonstrated by a comparison between the system of FIG. 3 and the system of FIG. 5. As demonstrated in FIG. 3, the features of the tube, such as the inner and outer edges of the wall that are distinctly visible in FIG. 3 are noticeably less visible in FIG. 5, such that the tube has a low visibility optical effect and is substantially invisible within the system.

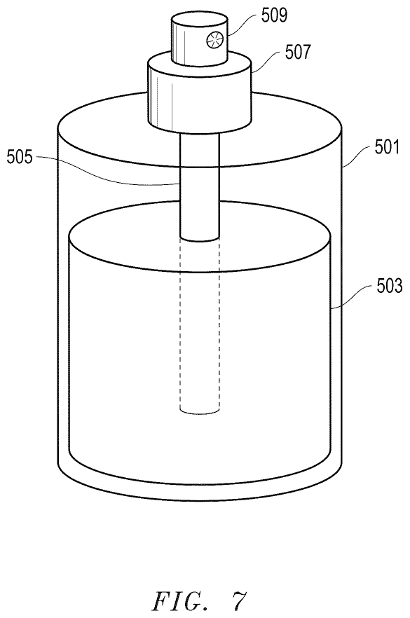

FIG. 6 illustrates a system in which a tube is both immersed in and contains a fluid in which the delta is approximately 0.02. Here, unlike the embodiments described above in connection with FIGS. 3 and 4, the refractive index of the liquid is greater than the tube. The low visibility optical effect of the system having a delta of 0.02 is demonstrated by a comparison of FIG. 6 to both FIGS. 3 and 4. As illustrated in FIG. 3, the features of the tube, such as the inner and outer edges of the wall are distinctly visible, however such features are noticeably less visible in FIG. 6 such that the tube has a low visibility optical effect. In a comparison of the systems of FIG. 6 and FIG. 4, the visibility of the tubes in either of the systems is roughly equivalent. The comparison of the low visibility optical effect is enhanced by the presence of an air pocket within a portion of the tube illustrated in FIG. 6. The presence of the air pocket within a portion of the tube demonstrates a portion of the system in which the delta is notably greater than 0.02. The inner wall and outer wall of the tube in the portion containing the air pocket is more visible than the portions of the tube containing the liquid. This comparison further illustrates the low visibility optical effect of providing a delta of about 0.02.

FIG. 7 illustrates an embodiment of a fragrance product including a container 501 housing a liquid fragrance 503, and further including a dispenser assembly having a transport assembly composed of cap structure 507 and pump member 509. Downward depression of pump member causes dispensing of the liquid fragrance, most often in an atomized fashion. The dispenser assembly further includes tube 505 that essentially disappears as it extends into the liquid fragrance 503, and functions to feed the transport assembly with continued supply of liquid fragrance until most of the liquid fragrance is used. In practice, embodiments have demonstrated a remarkable ability to achieve an almost completely disappearing tube as it extends into the liquid fragrance. When full, the fragrance product appears entirely ‘tubeless,’ the tube being virtually indiscernible upon casual inspection.

Although generally described as a tube, any reasonable article can be envisioned. The article may alternatively take the form of a film, a washer, or a fluid conduit. For example, the article may take the form or a film, such as a laminate, or a planar article, such as a septa or a washer. In another example, the article may take the form of a fluid conduit, such as tubing, a pipe, a hose or more specifically flexible tubing, transfer tubing, pump tubing, chemical resistant tubing, high purity tubing, smooth bore tubing, a polymer lined pipe, or rigid pipe, or any combination thereof. In a particular embodiment, the multilayer tube can be used as tubing or hosing where chemical resistance and transparency is desired. For instance, a tubing is a pump tube, such as for liquid dispensing, a peristaltic pump tube, or a liquid transfer tube, such as a chemically resistant liquid transfer tube.

Applications for the tubing are numerous. In an exemplary embodiment, the tubing may be used in applications such a cosmetic product, a beauty product, household wares, industrial, wastewater, digital print equipment, automotive, or other applications where transparency, clarity, chemical resistance, and/or low permeation to gases and hydrocarbons are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A tube includes: a layer including a polymer matrix and a refractive index domain dispersed within the polymer matrix, wherein the refractive index domain has a refractive index less than a refractive index of the polymer matrix, the layer having a refractive index of less than 1.42.

Embodiment 2. A method of forming a tube includes: providing a polymer matrix; and dispersing a refractive index domain in the polymer matrix wherein the refractive index domain has a refractive index less than a refractive index of the polymer matrix; and forming the polymer matrix into a layer, the layer having a refractive index of less than 1.42.

Embodiment 3. The tube or the method of forming the tube of any of the preceding embodiments, wherein the polymer matrix includes a non-fluoropolymer.

Embodiment 4. The tube or the method of forming the tube of embodiment 3, wherein the non-fluoropolymer includes a silicone polymer, a polyolefin, a polycarbonate, a cellulose triacetate, a cellulose ester, a polymethyl methacrylate, an epoxy, a cyclic olefin copolymer, a polyvinyl chloride, an amorphous copolyester, a polyethylene terephthalate, an ionomer resin, an acrylonitrile butadiene styrene (ABS), a styrene methyl methacrylate, a polystyrene, or combination thereof.

Embodiment 5. The tube or the method of forming the tube of embodiment 4, wherein the polyolefin includes a polymethyl pentene, a polypropylene, a cyclic olefin copolymer, or combination thereof.

Embodiment 6. The tube or the method of forming the tube of any of the preceding embodiments, wherein the polymer matrix has a refractive index of less than 1.60, such as 1.40 to 1.60, such as 1.45 to 1.50.

Embodiment 7. The tube or the method of forming the tube of any of the preceding embodiments, wherein the refractive index domain has an average diameter size of about 400 nanometer (nm) or less, such as 1 nm to 400 nm, such as 5 nm to 200 nm, such as 20 nm to 200 nm, or even 10 nm to 100 nm.

Embodiment 8. The tube or the method of forming the tube of any of the preceding embodiments, wherein the refractive index domain includes an air bubble, a hollow silica nanoparticle, a hollow glass nanoparticles, a hollow polymer nanoparticle, a silica aerogel, or combination thereof.

Embodiment 9. The tube or the method of forming the tube of embodiment 8, wherein the hollow polymer nanoparticle includes a polymer shell including a bio-based macromolecule, an amphiphilic polymer, a synthetic polymer, or combination thereof.

Embodiment 10. The tube or the method of forming the tube of embodiment 9, wherein the hollow polymer nanoparticle includes a cross-linked polymer shell.

Embodiment 11. The tube or the method of forming the tube of embodiment 9, wherein the bio-based macromolecule includes a protein, a lipid, a polypeptide, chitosan, or combination thereof.

Embodiment 12. The tube or the method of forming the tube of embodiment 9, wherein the amphiphilic polymer includes a polystyrene-poly(acrylic acid) block copolymer (PS-b-PAAC), a polyethylene oxide-poly(butyl acrylate) block copolymer (EO-b-PBA), or combination thereof.

Embodiment 13. The tube or the method of forming the tube of embodiment 9, wherein the synthetic polymer includes polysiloxane, polymethyl methacrylate (PMMA), polyvinyl alcohol (PVA), polyvinylidene difluoride (PVDF), polyvinyl chloride (PVC), acrylonitrile butadiene styrene (ABS), polylactic acid (PLA), polydopamine (PDM), polystyrene-poly(methyl methacrylate) copolymer (PS-PMMA), a cyclic olefin copolymer, or combination thereof.

Embodiment 14. The tube or the method of forming the tube of any of the preceding embodiments, wherein the refractive index domain is homogeneously dispersed within the polymer matrix.

Embodiment 15. The tube or the method of forming the tube of any of the preceding embodiments, wherein the refractive index domain is present at a volume fraction of about 5% to about 60% based on the total volume of the layer.

Embodiment 16. The tube or the method of forming the tube of any of the preceding embodiments, wherein the polymer matrix has a light transmission of greater than about 80%, such as greater than about 85%, such as greater than about 90%, or even greater than about 95%.

Embodiment 17. The tube or the method of forming the tube of any of the preceding embodiments, wherein the tube has a refractive index of 1.34 to 1.40, or even 1.36 to 1.38.

Embodiment 18. The tube or the method of forming the tube of any of the preceding embodiments, wherein the tube has an outside diameter within a range of about 0.25 mm to about 10.0 mm, such as a range of about 0.5 mm to about 5.0 mm.

Embodiment 19. The tube or the method of forming the tube of any of the preceding embodiments, wherein the tube has an inner diameter within a range of about 0.1 mm to about 3.0 mm, such as about 0.1 mm to about 2.0 mm, or even about 0.1 mm to about 1.0 mm.

Embodiment 20. The tube or the method of forming the tube of any of the preceding embodiments, wherein tube consists essentially of a single layer.

Embodiment 21. The tube or the method of forming the tube of any of the preceding embodiments, wherein the layer is a coating overlying an inner layer.

Embodiment 22. The tube or the method of forming the tube of any of the preceding embodiments, wherein the layer is an outer layer and an inner layer overlying a base layer.

Embodiment 23. The tube or the method of forming the tube of embodiment 22, wherein the inner layer and the outer layer are the same material.

Embodiment 24. The tube or the method of forming the tube of embodiment 23, wherein the base layer includes a different material.

Embodiment 25. The tube or the method of forming the tube of any of the preceding embodiments, wherein the tube is connected to a pump.

Embodiment 26. The tube or the method of forming the tube of any of the preceding embodiments, wherein the tube is immersed into a liquid fragrance.

Embodiment 27. The tube or the method of forming the tube of embodiment 26, wherein the liquid fragrance and the tube each have a refractive index, and a difference between the refractive index of the tube and the liquid fragrance is not greater than about 0.04, such as not greater than 0.03, or even not greater than 0.02.

Embodiment 28. The tube or the method of forming the tube of embodiment 8, wherein the air bubble is formed from a degradable nanoparticle.

Embodiment 29. The tube or the method of forming the tube of embodiment 28, wherein the degradable nanoparticle includes a silicone-polyethylene glycol (PEG) block copolymer, an ammonium bicarbonate encapsulated in a polymeric shell, an ammonium carbonate solution encapsulated in a polymeric shell, or combination thereof.

Embodiment 30. The method of forming the tube of embodiment 28, further including heating the tube to a temperature to degrade at least a portion of the degradable nanoparticle to form the air bubble.

Embodiment 31. The method of embodiment 2, wherein dispersing the refractive index domain includes providing a nano-foam.

Embodiment 32. The method of embodiment 2, wherein dispersing the refractive index domain includes providing an aerogel.

Embodiment 33. The method of embodiment 2, wherein dispersing the refractive index domain includes providing a multilayer polyelectrolyte coating.

Embodiment 34. A fragrance product includes: a container containing liquid fragrance; and a dispenser assembly for dispensing the liquid fragrance including: a transport assembly; and a tube connected to the transport assembly and extending into the liquid fragrance, wherein the tube includes a non-fluoropolymer matrix and a refractive index domain dispersed within the non-fluoropolymer matrix, wherein the refractive index domain has a refractive index less than a refractive index of the non-fluoropolymer matrix, the tube having a refractive index of less than 1.42.

Embodiment 35. The fragrance product of embodiment 34, wherein the liquid fragrance and the tube each have a refractive index, and a difference between the refractive index of the tube and the liquid fragrance is not greater than about 0.04, such as not greater than about 0.03, or even not greater than 0.02.

Embodiment 36. The fragrance product of embodiment 34, wherein the tube has a refractive index of 1.34 to 1.40, or even 1.36 to about 1.38.

Embodiment 37. The fragrance product of embodiment 34, wherein the non-fluoropolymer matrix includes a silicone polymer, a polyolefin, a polycarbonate, a cellulose triacetate, a cellulose ester, or combination thereof.

Embodiment 38. The fragrance product of embodiment 34, wherein the refractive index domain has an average diameter size of about 400 nanometer (nm), such as 20 nm to 400 nm, or even 20 nm to 200 nm.

Embodiment 39. The fragrance product of embodiment 34, wherein the refractive index domain includes an air bubble, a hollow silica nanoparticle, a hollow polymer nanoparticle, or combination thereof.

Embodiment 40. The fragrance product of embodiment 34, wherein the tube has an outside diameter within a range of about 0.25 mm to about 10.0 mm, such as a range of about 0.5 mm to about 5.0 mm.

Embodiment 41. The fragrance product of embodiment 34, wherein the tube has an inner diameter within a range of about 0.1 mm to about 3.0 mm, such as about 0.1 mm to about 2.0 mm, or about 0.1 mm to about 1.0 mm.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

PMP-Aerogel Compounding and Extrusion

Polymethylpentene (PMP) was loaded into a benchtop twin screw extruder (Xplore MC 15 HT, Xplore Instruments) and allowed to melt within the equipment for 1 minute at a screw speed 100 RPM with temperature setpoints between 240° C.-280° C. Aerogel was added at the desired loading level (5 wt. %) and allowed to compound for 2 minutes at 40-60 RPM. Extrusion of a film was performed by opening the die channel and extruding the material between 80-100 RPM. The extruded film was taken up on a roll with a torque value between 60-70 N-m.

Optical Characterization

Optical characterization of the films was performed using a spectrophotometer (UltraScan Pro 1639, HunterLab) and an Abbe refractometer (Leica Mark II, Reichert Analytical Instruments). The haze and refractive index of each film was measured and compared in Table 1.

TABLE 1
Optical comparison of PMP-aerogel composite films.

| | Thickness | Extrusion | Haze % | Refractive |
|---|---|---|---|---|
| Sample | (mm) | Speed (RPM) | (D65/10) | Index |
| PMP Control | 0.306 | 100 | 11.4 ± 0.6 | 1.464 |
| 5% silica aerogel, | 0.307 | 80 | 20.1 ± 1.3 | 1.421 |
| 80 RPM | | | | |
| 5% silica aerogel, | 0.305 | 100 | 15.5 ± 0.9 | 1.421 |
| 100 RPM | | | | |

### Example 2

Particle Size Reduction

The effect of aerogel particle size on the haze of the PMP-aerogel composite was investigated by milling aerogel to finer particle size. Silica aerogel was jet-milled for 5.5 hours to a mean particle size of about 7 μm. The jet-milled silica aerogel was compared to a virgin silica aerogel (i.e., unmilled) with a mean particle size about 9 μm.

PMP-Aerogel Compounding and Extrusion

Polymethylpentene (PMP) was loaded into a benchtop twin screw extruder (Xplore MC 15 HT, Xplore Instruments) and allowed to melt within the equipment for 1 minute at a screw speed 100 RPM with temperature setpoints between 240° C.-280° C. Aerogel was added at the desired loading level (8 wt. %) and allowed to compound for 2 minutes at 40-60 RPM. Extrusion of a film was performed by opening the die channel and extruding the material at 100 RPM. The extruded film was taken up on a roll with a torque value between 60-70 N-m.

Optical Characterization

Optical characterization of the films was performed using a spectrophotometer (UltraScan Pro 1639, HunterLab) and an Abbe refractometer (Leica Mark II, Reichert Analytical Instruments). The haze and refractive index of each film was measured and compared in Table 2. In the case of virgin silica aerogel (i.e., unmilled) filler, the haze was too high to measure refractive index.

TABLE 2
Optical comparison of PMP-aerogel composite films.

| | Thickness | Aerogel | Haze % | Refractive |
|---|---|---|---|---|
| Sample | (mm) | Particle Size | (D65/10) | Index |
| PMP Control | 0.306 | n.a. | 11.4 ± 0.6 | 1.464 |
| 8% Silica aerogel, | 0.304 | 9 μm | 68.2 ± 0.2 | n.a. |
| virgin | | | | |
| 8% Silica aerogel, | 0.304 | 7 μm | 19.1 ± 1.1 | 1.420 |
| milled | | | | |

### Example 3. Film of Silicone/Hollow Silica Nanoparticles by Casting and Curing

10-mil (250 μm) thick films are cast from a LSR by dispersing various volume fractions of 50 nm hollow silica nanoparticles (e.g., 5%, 10%, 20%, 30%, 40%, and 50%) in LSR using a mixing apparatus. The film is then UV or heat cured. The refractive index, haze, light transmission, and tensile modulus of these samples are measured, and the tube is desirable for fragrance tubes.

### Example 4. Film of PMP/Hollow Silica Nanoparticles by Solution Casting

PMP is first dissolved in an organic solvent such as hexane or cyclohexane. The appropriate amount of silica hollow nanoparticles is also dispersed in the same organic solvent using a mixing apparatus. Afterwards, the two mixtures are mixed, and sonication is used to form a homogeneous mixture. 10-mil (250 μm) thick films are cast from the PMP solution by dispersing various volume fractions of 50 nm hollow silica nanoparticles (e.g., 5%, 10%, 20%, 30%, 40%, and 50%). The refractive index, haze, light transmission, and tensile modulus of these samples are measured, and the results are desirable.

### Example 5. Silicone/Hollow Silica Nanoparticle Composite Tube Made by Injection Molding

LSR composite tubes are made by dispersing various volume fractions of 50 nm hollow silica nanoparticles (with a specified particle volume fraction) in LSR and mixed using a mixing apparatus. Afterwards, the tube is fabricated via injection molding. The tube is then immersed in IPA solution and evaluated under ambient and direct light. Images of the tube in IPA solution are shown in the figure below.

### Example 6. Silicone/Hollow Silica Nanoparticle Composite Tube Made by B-Staging Followed by Extrusion

The homogeneous mixture of LSR/hollow silica nanoparticles is partially cured (B-staged). The partially cured silicone is then extruded into a tube. The tube is subsequently immersed in IPA solution and evaluated under ambient and direct light.

### Example 7. PMP/Hollow Silica Nanoparticle Composite Tube Made by Extrusion

The tube is made by extrusion (twin screw extrusion is desirable). The silica nanoparticles are added either upstream of the extruder or downstream after the PMP is melted. Distributive and dispersive mixing elements are used in the screw design to facilitate the mixing of nanoparticles with PMP. The tube is subsequently immersed in IPA solution and evaluated under ambient and direct light. Images of the tube in IPA solution are shown in the figure below.

### Comparative Example 1: Film of Silicone/Hollow Silica Nanoparticles by Casting and Curing

10-mil (250 μm) thick films are cast from a LSR by dispersing various volume fractions of 300 nm hollow silica nanoparticles, following the identical procedure as in example 1 except that 300 nm nanoparticles are used. The refractive index, haze, light transmission, and tensile modulus of these samples are measured.

### Comparative Example 2: Film of PMP/Hollow Silica Nanoparticles by Solution Casting

10-mil (250 μm) thick films are cast from a PMP solution by dispersing various volume fractions of 300 nm hollow silica nanoparticles, following the identical procedure as in example 2 except that 300 nm nanoparticles are used. The refractive index, haze, light transmission, and tensile modulus of these samples are measured.

### Example 8. Film of Silicone+Silicone-PEG Block Copolymer by Casting, Curing, and Elevated Temperature Treatment

10-mil (250 μm) thick films are cast from a LSR and silicone-PEG block copolymer by mixing silicone-PEG block copolymer and LSR at various ratio. (e.g., 5, 10, 20, 30, and 40 wt %) of silicone-PEG block copolymer using a mixing apparatus. The film is then UV or heat cured. Afterwards, the film is heated to a temperature slightly below 200° C. overnight to degrade the PEG domain. The PEG decomposition creates nanovoids that are well disposed in the silicone matrix to reduce the refractive index of the tube. The refractive index, haze, light transmission, and tensile modulus of these samples are measured, and the results are summarized.

### Example 9. Film of Silicone+Encapsulated Ammonium Bicarbonate by Casting, Curing, and Elevated Temperature Treatment

First, nanoparticles with encapsulated ammonium bicarbonate are made. 10-mil (250 μm) thick films are cast from a LSR by dispersing various volume fractions of ammonium bicarbonate containing nanoparticles (e.g., 5%, 10%, 20%, 30%, 40%, and 50%) in LSR using a mixing apparatus. The film is then UV or heat cured. Afterwards, the film is heat treated at 80° C. or 100° C. for 30 minutes. Finally, the refractive index, haze, light transmission, and tensile modulus of these samples are measured, and the results are summarized.

### Example 10. Film of Silicone+Encapsulated Ammonium Bicarbonate by Casting, Curing, and Elevated Temperature Treatment

First, nanoparticles with encapsulated ammonium carbonate are made. 10-mil (250 μm) thick films are cast from a LSR by dispersing various volume fractions of ammonium carbonate containing nanoparticles (e.g., 5%, 10%, 20%, 30%, 40%, and 50%) in LSR using a mixing apparatus. The film is then UV or heat cured. Afterwards, the film is heat treated at 60° C. or 80° C. for 30 minutes. Finally, the refractive index, haze, light transmission, and tensile modulus of these samples are measured, and the results are summarized.

### Example 11. Film of PMP/Hollow Polymer Nanoparticles by Solution Casting Followed by Solid State Foaming

PMP is first dissolved in an organic solvent such as hexane or cyclohexane. 10-mil (250 μm) thick PMP films are cast from the PMP solution. The PMP film is foamed using super critical CO₂ foaming methods. In order to control the pore size and porosity (e.g., 10-20 vol %), relative short foaming time is used. The refractive index, haze, light transmission, and tensile modulus of these samples are measured, and the results are summarized.

Note that not all of the activities described above in the general description, or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tube comprises:
a layer comprising a polymer matrix and a refractive index domain dispersed within the polymer matrix, wherein the refractive index domain has a refractive index less than a refractive index of the polymer matrix, the layer having a refractive index of less than 1.42.

2. The tube in accordance with claim 1, wherein the polymer matrix comprises a non-fluoropolymer.

3. The tube in accordance with claim 2, wherein the non-fluoropolymer comprises a silicone polymer, a polyolefin, a polycarbonate, a cellulose triacetate, a cellulose ester, a polymethyl methacrylate, an epoxy, a cyclic olefin copolymer, a polyvinyl chloride, an amorphous copolyester, a polyethylene terephthalate, an ionomer resin, an acrylonitrile butadiene styrene (ABS), a styrene methyl methacrylate, a polystyrene, or combination thereof.

4. The tube in accordance with claim 3, wherein the polyolefin comprises a polymethyl pentene, a polypropylene, a cyclic olefin copolymer, or combination thereof.

5. The tube in accordance with claim 1, wherein the polymer matrix comprises has a refractive index of less than 1.60.

6. The tube in accordance with claim 1, wherein the refractive index domain has an average diameter size of about 400 nanometer (nm) or below.

7. The tube in accordance with claim 1, wherein the refractive index domain comprises an air bubble, a hollow silica nanoparticle, a hollow polymer nanoparticle, a hollow glass particle, an aerogel, or combination thereof.

8. The tube in accordance with claim 7, wherein the hollow polymer nanoparticle comprises a polymer shell comprises a bio-based macromolecule, an amphiphilic polymer, a synthetic polymer, or combination thereof.

9. The tube in accordance with claim 8, wherein the bio-based macromolecule comprises a protein, a lipid, a polypeptide, chitosan, or combination thereof.

10. The tube in accordance with claim 8, wherein the amphiphilic polymer comprises a polystyrene-poly(acrylic acid) block copolymer (PS-b-PAAC), a polyethylene oxide-poly(butyl acrylate) block copolymer (EO-b-PBA), or combination thereof.

11. The tube in accordance with claim 8, wherein the synthetic polymer comprises polysiloxane, polymethyl methacrylate (PMMA), polyvinyl alcohol (PVA), polyvinylidene difluoride (PVDF), polyvinyl chloride (PVC), acrylonitrile butadiene styrene (ABS), polylactic acid (PLA), polydopamine (PDM), polystyrene-poly(methyl methacrylate) copolymer (PS-PMMA), a cyclic olefin copolymer, or combination thereof.

12. The tube in accordance with claim 1, wherein tube consists essentially of a single layer.

13. The tube in accordance with claim 1, wherein the layer is a coating overlying an inner layer.

14. The tube in accordance with claim 7, wherein the air bubble is formed from a degradable nanoparticle.

15. The tube in accordance with claim 14, wherein the degradable nanoparticle comprises a silicone-polyethylene glycol (PEG) block copolymer, an ammonium bicarbonate encapsulated in a polymeric shell, an ammonium carbonate solution encapsulated in a polymeric shell, or combination thereof.

16. A fragrance product comprises:
a container containing liquid fragrance; and
a dispenser assembly for dispensing the liquid fragrance comprising:
a transport assembly; and
a tube connected to the transport assembly and extending into the liquid fragrance, wherein the tube comprises a non-fluoropolymer matrix and a refractive index domain dispersed within the non-fluoropolymer matrix, wherein the refractive index domain has a refractive index less than a refractive index of the non-fluoropolymer matrix, the tube having a refractive index of less than 1.42.

17. The fragrance product in accordance with claim 16, wherein the liquid fragrance and the tube each have a refractive index, and a difference between the refractive index of the tube and the liquid fragrance is not greater than about 0.04.

18. The fragrance product in accordance with claim 16, wherein the refractive index domain comprises an air bubble, a hollow silica nanoparticle, a hollow polymer nanoparticle, or combination thereof.

19. A method of forming a tube comprises:
providing a polymer matrix; and
dispersing a refractive index domain in the polymer matrix wherein the refractive index domain has a refractive index less than a refractive index of the polymer matrix; and
forming the polymer matrix into a layer, the layer having a refractive index of less than 1.42.

20. The method in accordance with claim 19, wherein dispersing the refractive index domain comprises providing a nano-foam, an aerogel, a multilayer polyelectrolyte coating, or combination thereof.
